(19) United States
(12) Patent Application Publication
(10) Pub. No.: US 2008/0192566 A1
(43) Pub. Date: Aug. 14, 2008

(54) Liquid Mixing Device

(75) Inventors: Koji Yamashita, Okayama (JP); Masayuki Shigemoto, Okayama (JP); Motoi Masuda, Okayama (JP)

Correspondence Address: OLIFF & BERRIDGE, PLC, P.O. BOX 320850, ALEXANDRIA, VA, 22320-4850, US

(73) Assignee: HSP CO., LTD., Okayama-shi, Okayama (JP)

(21) Appl. No.: 11/666,425

(22) PCT Filed: Apr. 14, 2006
(86) PCT No.: PCT/JP2006/307924

§ 371 Date: Apr. 27, 2007

(30) Foreign Application Priority Data
Apr. 15, 2005 (JP) 2005-117848

(51) Int. Cl. B01F 5/04; B01F 3/08

(52) U.S. Cl. 366/173.2; 366/137.1; 366/177.1

(57) ABSTRACT

The liquid mixing device has an operative mixing unit having an inside which is substantially hollow; and an injection unit provided in the inside of the operative mixing unit. The injection unit is adapted for allowing a second liquid to be injected into the inside of the operative mixing unit, and the operative mixing unit is provided with: an inlet port for allowing a first liquid to flow thereinto; and an outlet port. The injection unit is provided with an injector element of a tubular form which has: an injection hole(s) so perforated therein as to face toward the outlet port; and an opening region defined therein so as to allow the first liquid to pass rectilinearly therethrough in a direction from the inlet port toward the outlet port. The injector element may be of a generally ringed shape or of a generally “U” shape.

### FIELD OF THE INVENTION

The present invention relates to a liquid mixing device for mixing two or more different liquids with one another.

### BACKGROUND ARTS

There have been various methods by which two different liquids or a plurality of different liquids can be intermixed with one another. Most of liquid mixing devices available for effecting such methods is provided with an operative mixing unit in which different liquids are to be intermixed with one another. In normal operation of the liquid mixing device, the liquids are trapped in that operative mixing unit and then intermixed with one another therein. Some of the liquid mixing methods use a rotating stirrer for example, as typically disclosed from the Japanese Laid-Open Patent Publication No. 6-277482.

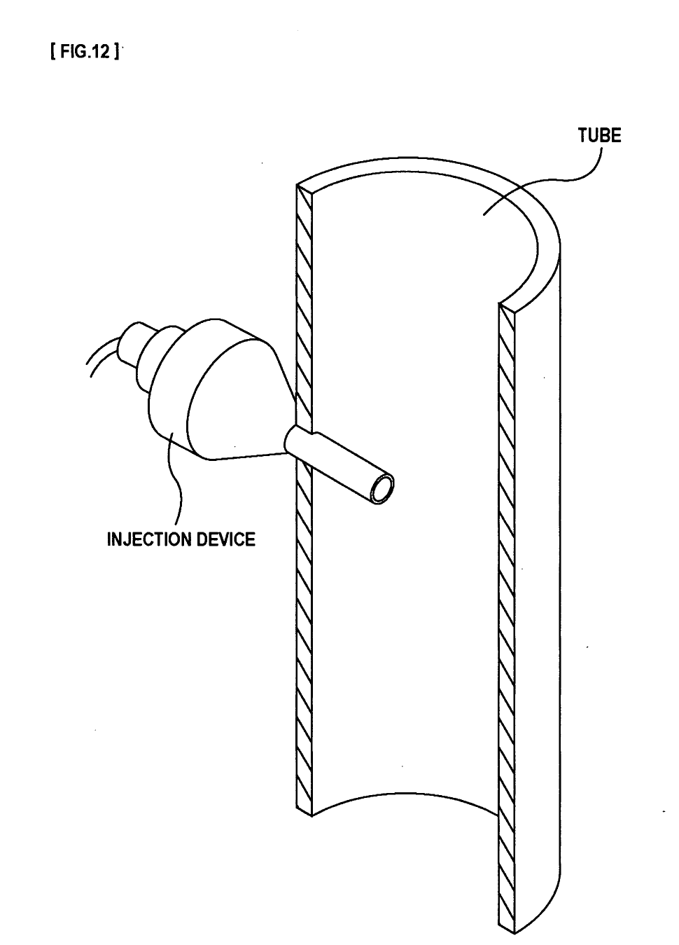

But, there are some liquid mixing methods without the foregoing operative mixing unit therein. For instance, as shown in FIG. 12, a direct mixing method is known, which uses a tube through which a first liquid flows and an injection device from which a second liquid is directly injected into the tube and mixed into the first liquid. The injection device shown in FIG. 12 is a known injection valve or an equivalent thereof, and it is to be understood that the second liquid is injected from such valve and mixed directly into the first liquid in the tube.

Cited patent literature 1: the Japanese Laid-Open Patent Publication No. 6-277482

### PROBLEMS TO BE SOLVED TO BE SOLVED BY THE PRESENT INVENTION

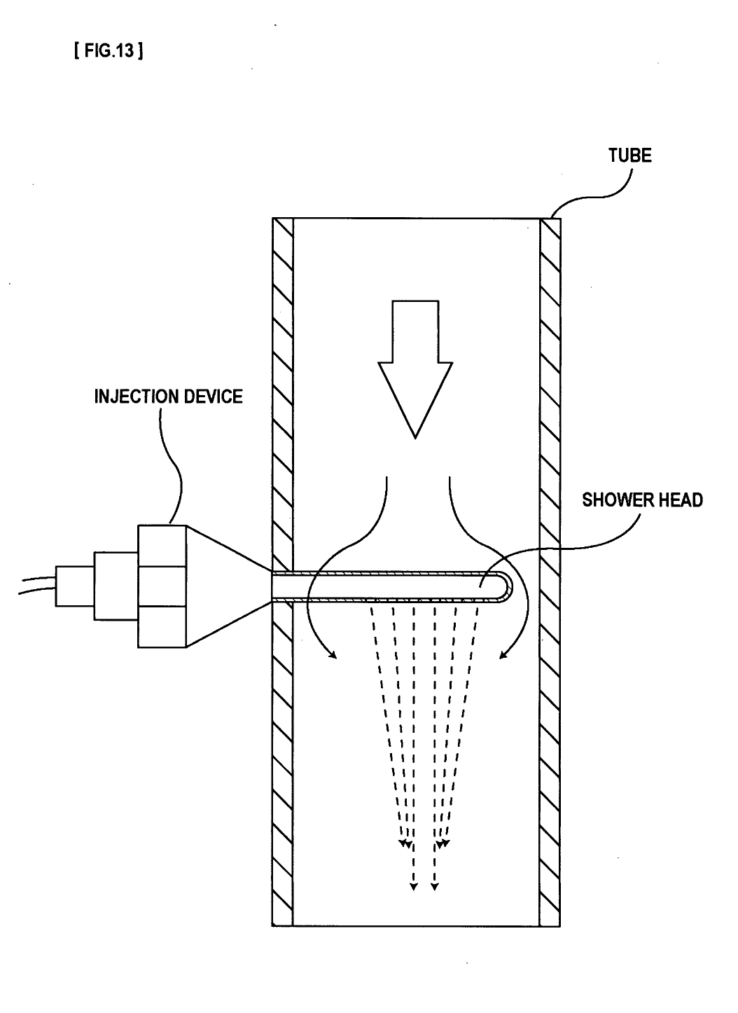

The above-mentioned mixing method as illustrated in FIG. 12 is however insufficient to mix the second liquid with the first liquid to a satisfied degree and therefore requires alteration and improvement to achieve a satisfactory intermixing of those two liquids and also requires altering and improving a shape of an injection device used, for that purpose. To solve such problem, as shown in FIG. 13, there is known a mixing method in which a shower head is used as an injection hole means. It is seen therefrom that a first liquid flows as indicated by the solid arrow, while a second liquid flows as indicated by the dotted arrow. But, according to this method, as understandable from the FIG. 13, the first liquid flows against the shower head and thus changes its stream in a different direction from that shower head. Then, the first liquid, flowing outwardly of the shower head and passing the same, is naturally drawn toward a center of tube. Due to such abrupt inward flow of first liquid, a plurality of second liquid streams being injected from the respective holes of the shower head are also drawn toward the center of tube, which has raised the problem that the plural individual flows of second liquid are pressed by the inwardly flowing first liquid into one squeezed flow which simply moves along with the flow of first liquid, and therefore, the second liquid is not mixed with the first liquid as required. This insufficient mixing results in inconstant pH variations and inhomogeneous ingredient concentration in a mixture of the first and second liquids, thus making it difficult to provide a stable quality of a resultant liquid product and posing a problem in quality. In this context, if an aqueous hypochlorite solution is injected and mixed into the first liquid according to the method shown in FIG. 13, a high concentration of hypochlorite is found to be present partially in a resultant liquid mixture due to insufficient mixing, as a result of which, the hypochlorite chemically affects the tube, hence raising the problem that the tube will be corroded. Further, if the same method as in the FIG. 13 is effected to admix an aqueous hypochlorite solution with an acid solution, a resultant mixed solution will contain some high concentration regions of hypochlorite where a high concentration of hypochlorite in excess of a given level has been intermixed with the acid solution, which will generate chlorine gas therefrom, thus raising the problem that a final solution produced in this method indicates an extraordinary unstable pH state.

A mixing device with rotating stirrer may certainly achieve a sufficient mixing of different liquids, which will therefore lessen the likelihood of the afore-stated inconstant pH variations and the afore-sated inhomogeneous ingredient concentration in a resultant liquid mixture. But, the rotating stirrer itself requires maintenance, which will increase costs involved, leaving thus a problem in economy. Further, if there is a demand for mass production of resultant mixed solution, a large-sized rotating stirrer will be required, in which case, a problem will arise in the necessity for providing a huge source of power for causing operation of large mixing device and rotating stirrer, a large installation space, and a substantive amount of costs involved therein.

In view of the foregoing problems, there has been a great demand on development and production of an improved liquid mixing device which is of an inexpensive and simplified structure requiring no or little maintenance and capable of not only injecting the afore-said second liquid or solution into the afore-said first liquid uniformly for homogeneous mixing purpose, but also mixing a plurality of different liquids with one another in a required homogenous manner.

### MEANS FOR SOLVING THE PROBLEMS

In order to solve the above-discussed problems, a liquid mixing device in accordance with the present invention is characterized by comprising: an operative mixing unit having an inside which is substantially hollow; and an injection unit provided in the inside of the operative mixing unit, the injection unit being adapted for allowing a second liquid to be injected into the inside of the operative mixing unit, wherein the operative mixing unit is provided with: an inlet port for allowing a first liquid to flow thereinto; and an outlet port disposed in opposingly facing relation with the inlet port, wherein the injection unit is provided with an injector element of a tubular form, the injector element having: an injection hole(s) so perforated therein as to face toward the outlet portion; and an opening region defined therein so as to allow the first liquid to pass rectilinearly therethrough in a direction from the inlet portion toward the outlet portion.

As one aspect of the present invention, the injector element may be disposed orthogonal to a line extending through a center of the inlet port and a center of the outlet port.

As another aspect of the invention, a plurality of the injector elements may be provided in the inside of the operative mixing unit.

As still another aspect of the invention, the outlet port may be provided with an outlet extension so formed to have a generally cylindrical body which extends from a base end of the outlet port in such a manner as to project from said particular base end towards a center of said operative mixing unit. And also, a plurality of discharge holes be formed in a peripheral surface of such generally cylindrical body.

The afore-said injector element may be of a generally ringed shape.

Or, alternatively, the injector element be of a generally “U” shape.

As yet still another aspect of the invention, the injector element may comprise: a ringed connecting tube; and a plurality of injector heads connected with that ringed connecting tube. Such plurality of injector heads each has the afore-said injection holes and projects towards a center of the ringed connecting tube.

Further, in accordance with the liquid mixing device of the present invention, one of the afore-said first and second liquids may be a solution of hydrochloric acid, whereas another of them liquids be a solution of hypochlorite.

### EFFECTS OF THE PRESENT INVENTION

As described above, the liquid mixing device in accordance with the present invention is comprised of: an operative mixing unit having an inside which is substantially hollow; and an injector unit provided in the inside of the operative mixing unit, the injector unit being adapted for allowing a second liquid to be injected into the inside of the operative mixing unit, wherein the operative mixing unit is provided with: an inlet port for allowing a first liquid to flow thereinto; and an outlet port disposed in opposingly facing relation with the inlet port, wherein the injector unit is provided with an injector element of tubular configuration, said injector element having: an injection hole(s) so perforated therein as to face toward the outlet port; and an opening region defined therein so as to allow the first liquid to pass rectlinearly therethrough in a direction from the inlet port toward the outlet port. Accordingly, the liquid mixing device is of a simplified structure that does not impede passage of the first and second liquids therethrough and effectively permits those two liquids to be intermixed well together therein. Hence, even in the midst of the first liquid flowing through the operative mixing unit, the second liquid can be directly injected thereinto and intermixed with the first liquid well, which is most advantageously effective in miniaturization of the operative mixing unit itself as well as in a smallest possible reduction of undesired spaces occupied by that liquid mixing device. Further, in accordance with the present invention, the second liquid injected in the operative mixing unit is forcibly drawn to a main stream of the first liquid therein, thereby enabling a sufficient intermixing of the two liquids, so that there is no undesirable changes of pH in a resultant liquid mixture, and further, the resultant liquid mixture has no inhomogeneous concentration of the mixed two liquids therein.

Additionally, the outlet port is provided with an outlet extension so formed to have a generally cylindrical body which extends from a base end of the outlet port which is connected with the operative mixing unit, in such a manner as to project from that base end towards a center of the operative mixing unit, and a plurality of discharge holes are formed in a peripheral surface of the generally cylindrical body. Thus, as both first and second liquids flow along such outlet extension, a reversed flow of the first and second liquids occurs adjacent to the outlet extension due to a crosscurrent flow of the two liquids into each of the discharge holes, thereby causing sufficient intermixing of the first and second liquids.

Further, the liquid mixing device is of quite simplified structure which allows for easy maintenance thereof or requires no maintenance. Furthermore, the operative mixing unit thereof may be connected with any suitable tubing in the possession of a user, to thereby easily assemble a desired mode of liquid mixing device. Hence, the present invention is adaptable for versatile uses.

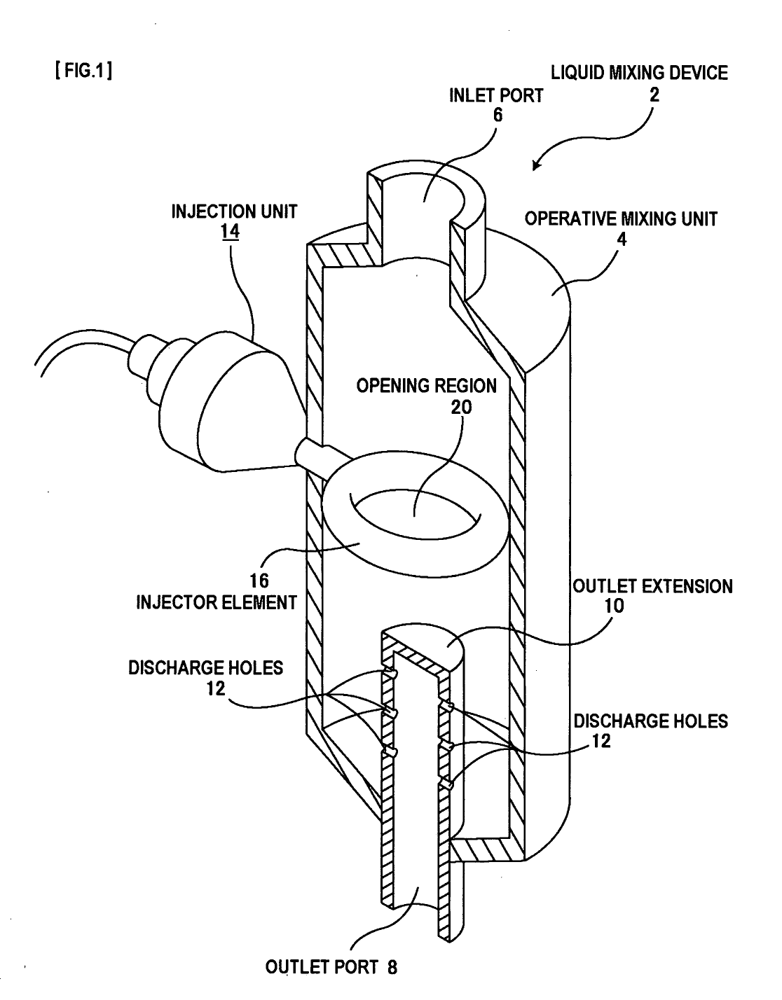

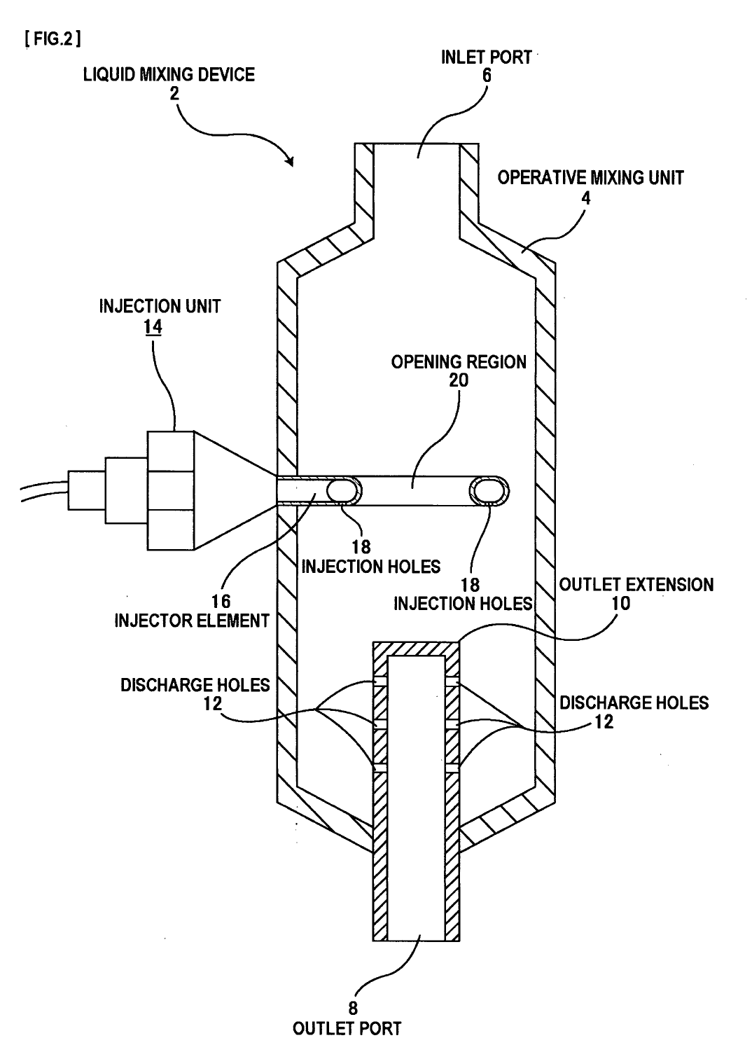

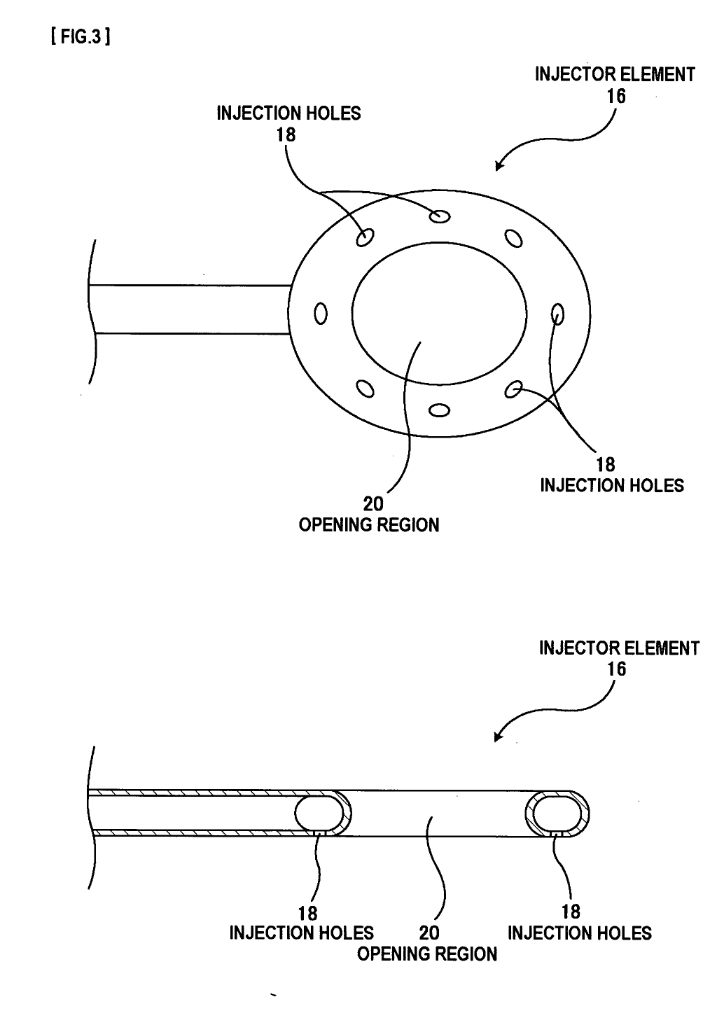

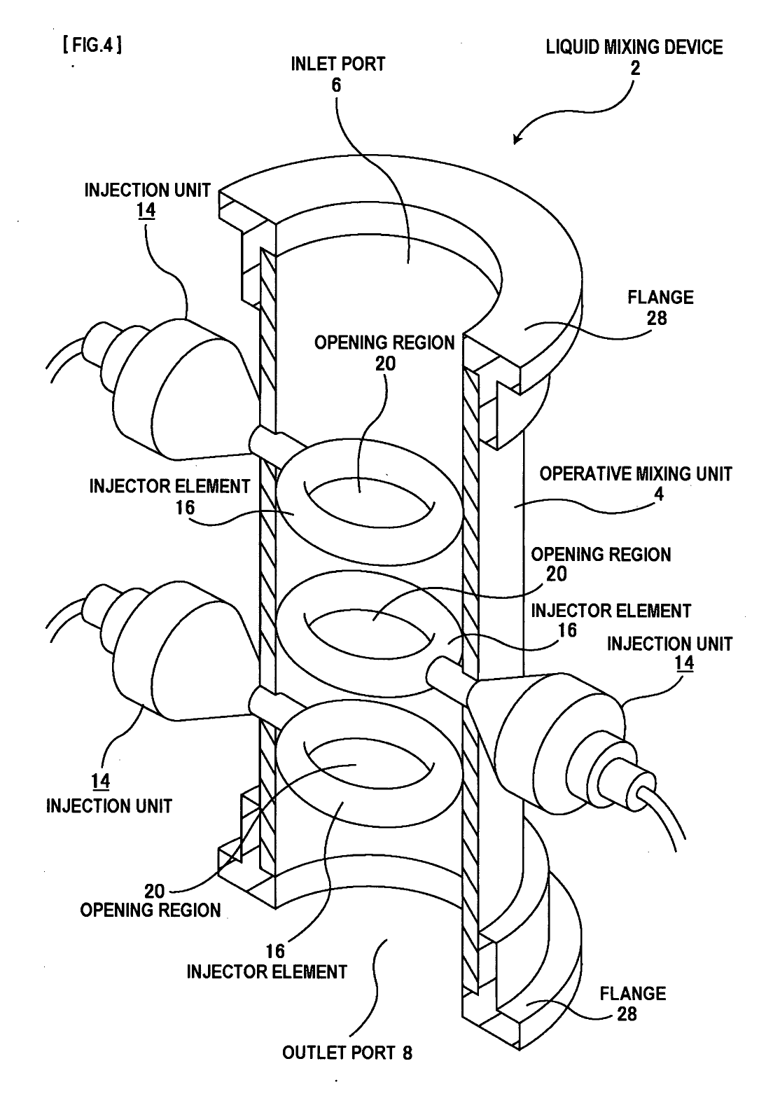

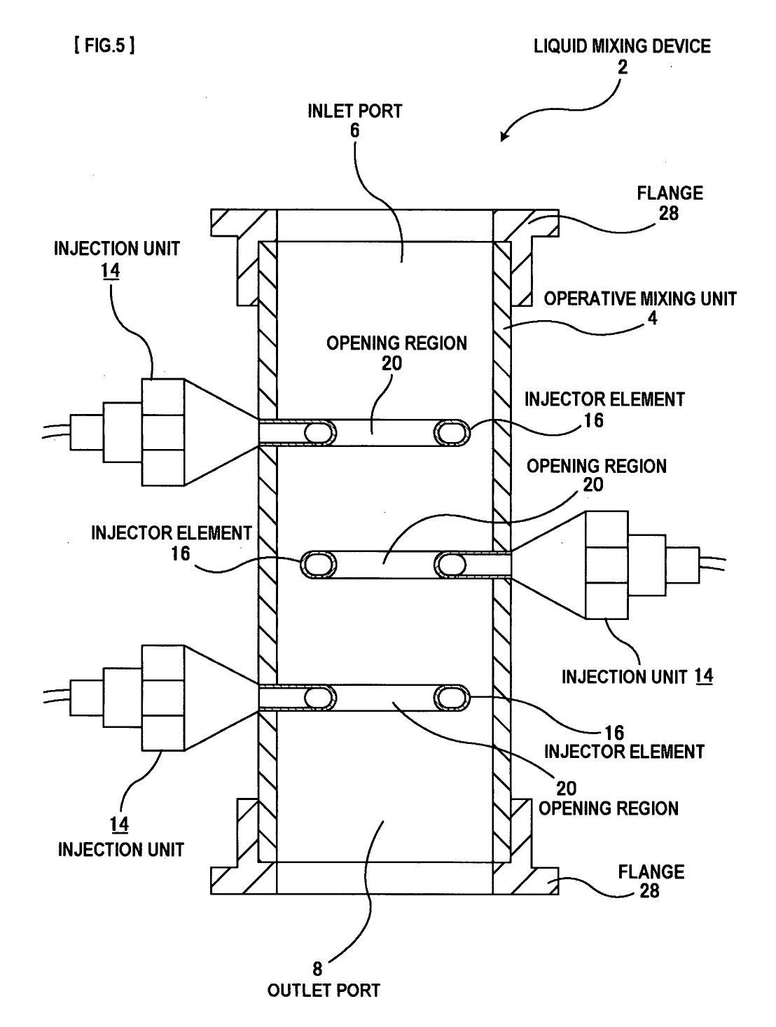

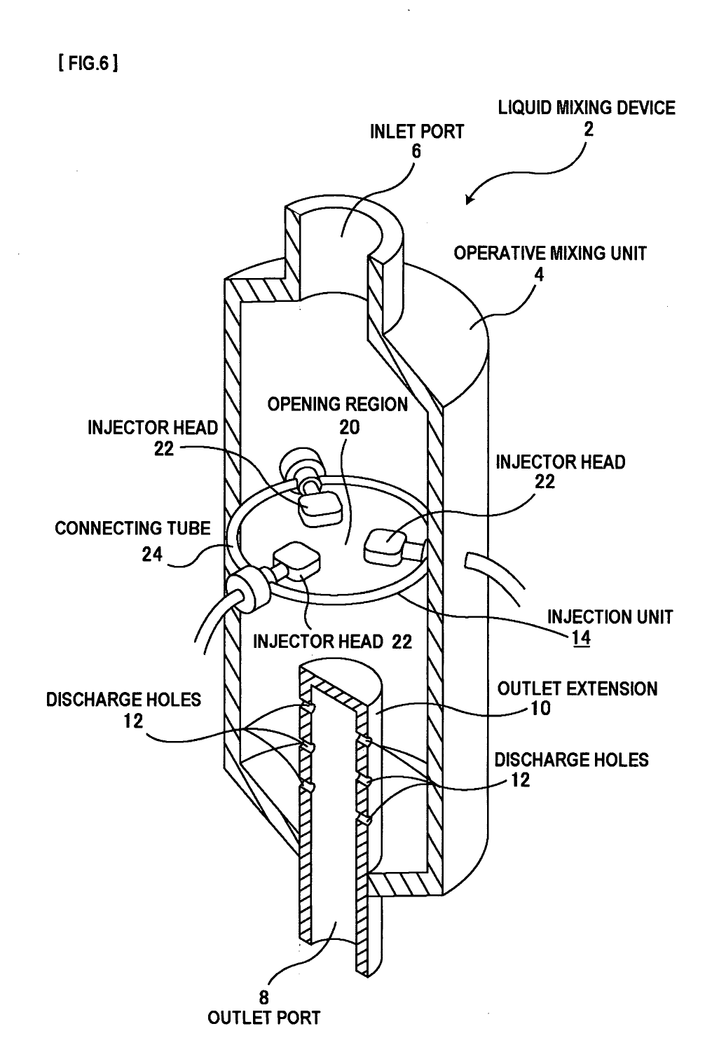

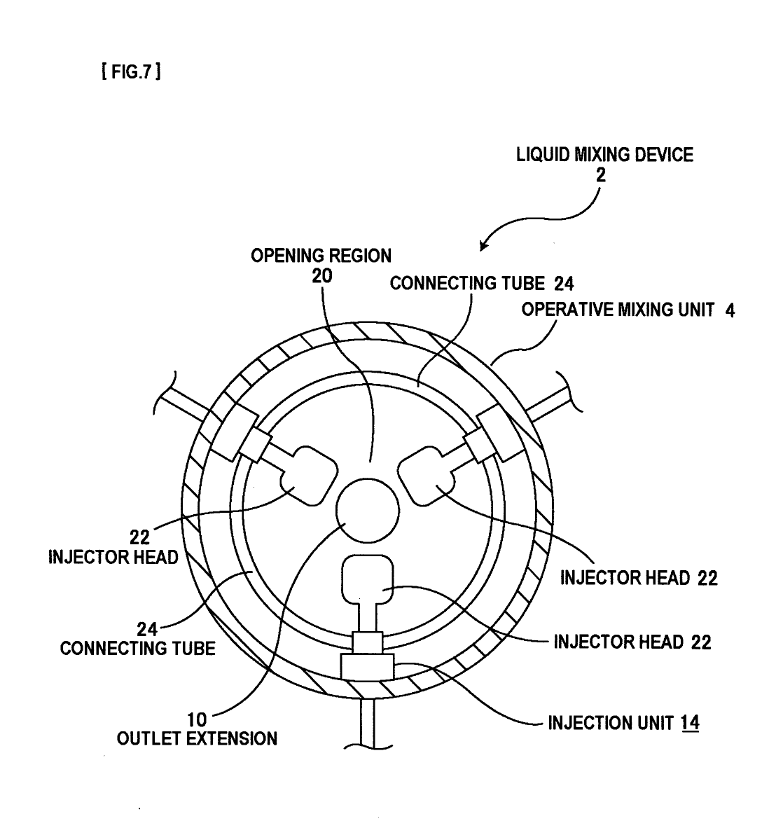

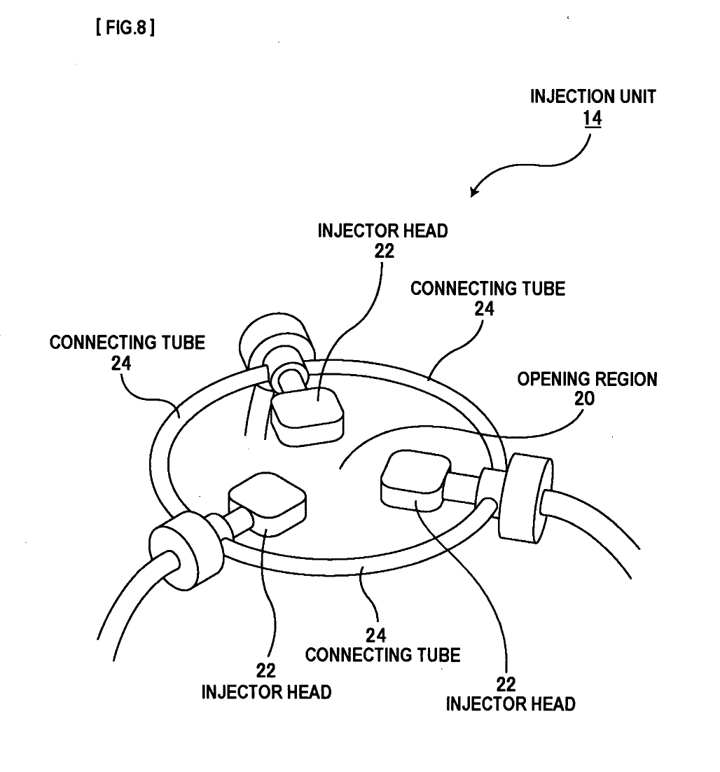

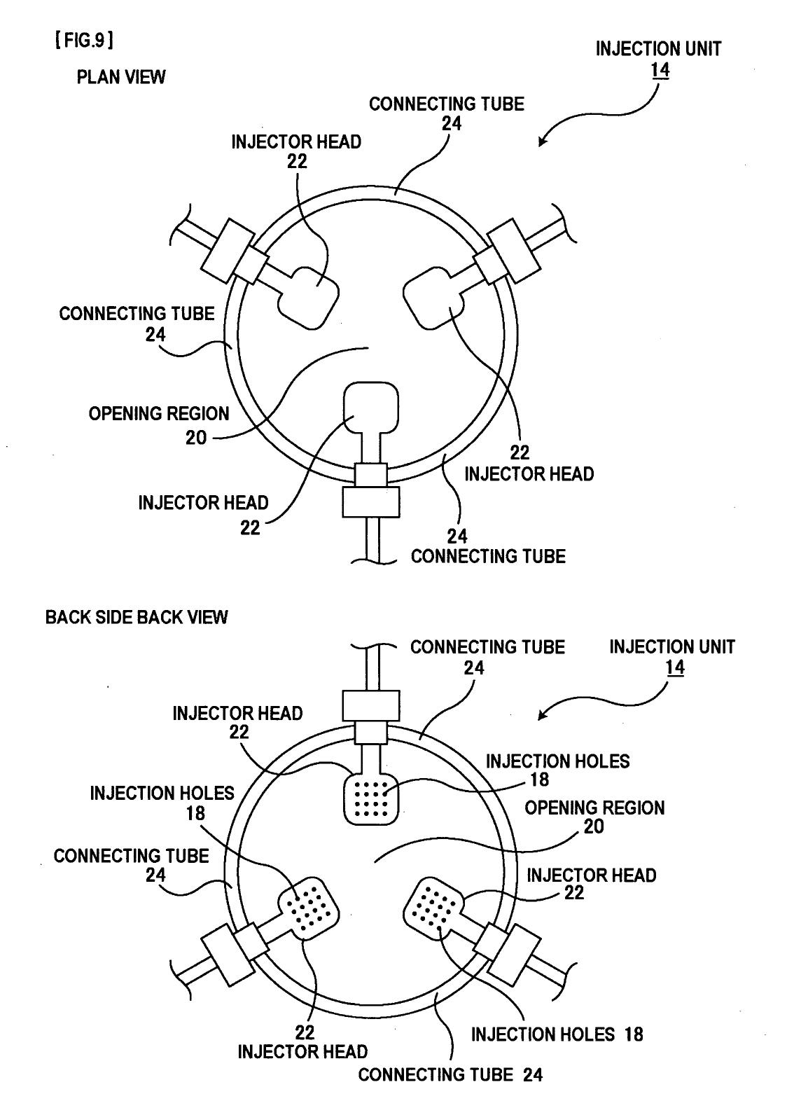

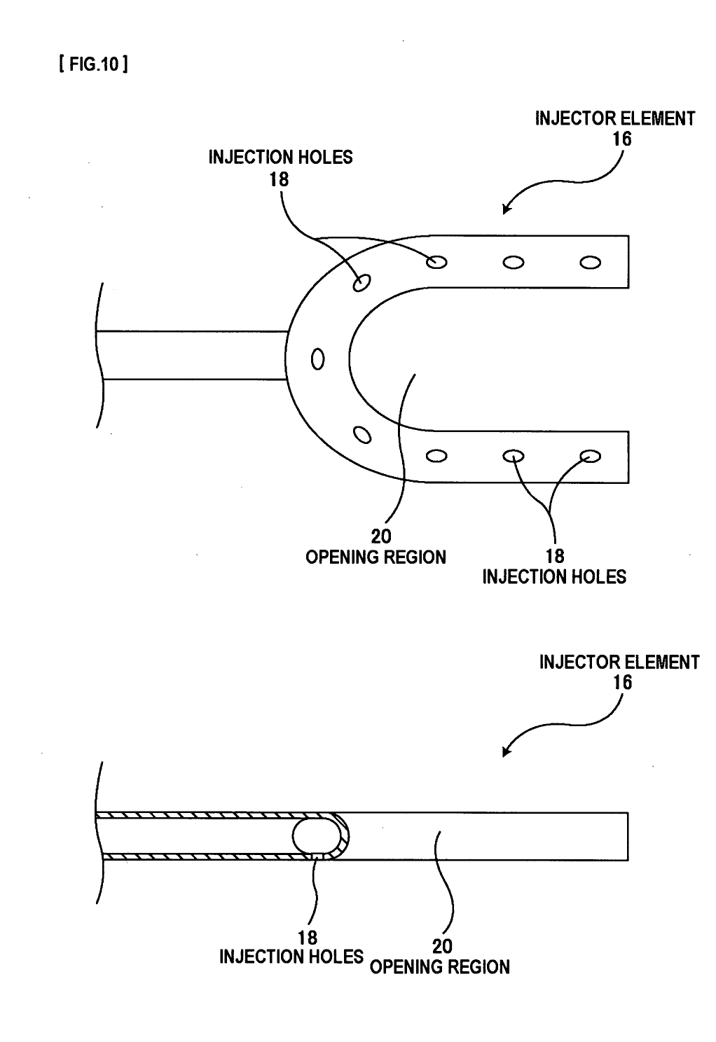

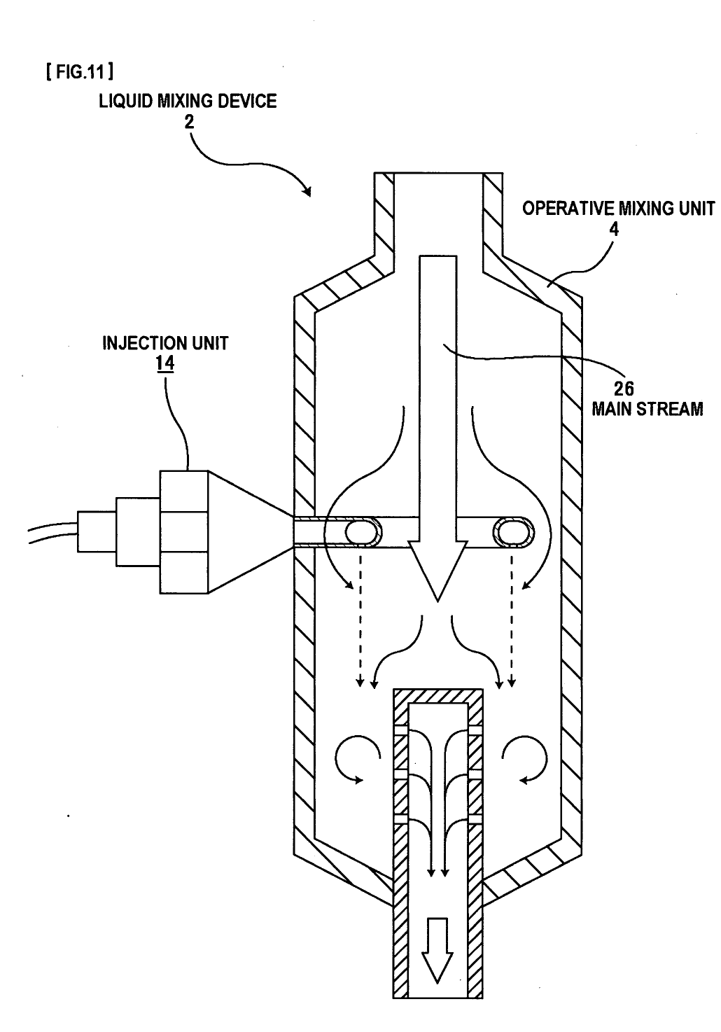

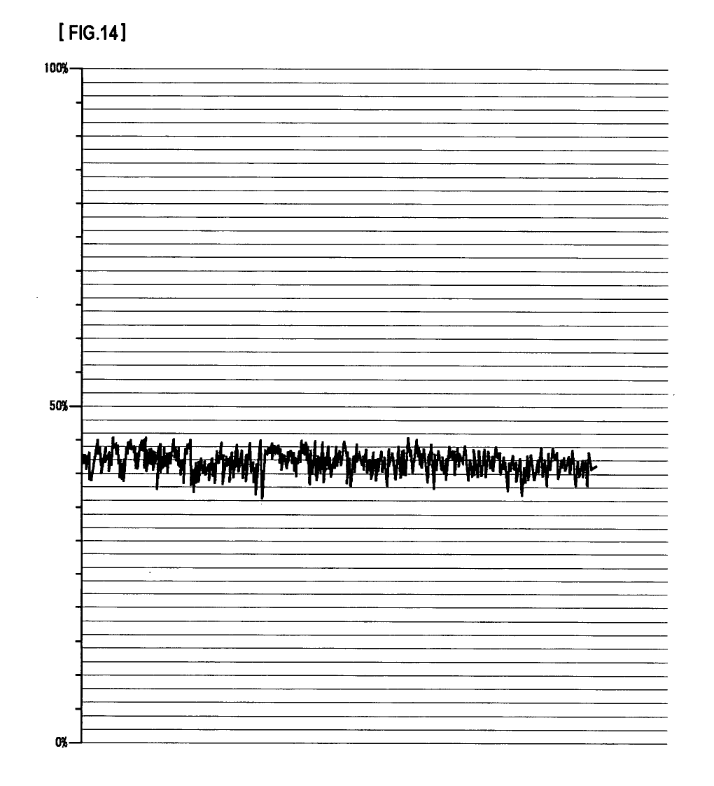

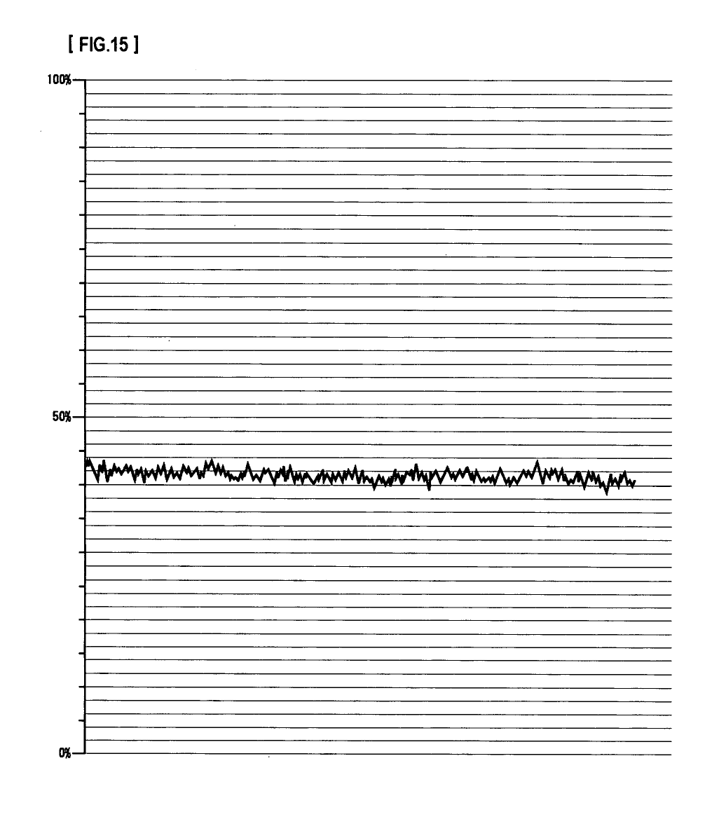

### BRIEF DESCRIPTION OF THE DRAWINGS

[FIG. 1]: A diagram for illustrating one exemplary embodiment of liquid mixing device in accordance with the present invention.

[FIG. 2]: A fragmentary sectional view of such one exemplary embodiment of liquid mixing device in accordance with the present invention.

[FIG. 3]: A diagram for showing one exemplary embodiment of injector element in accordance with the present invention.

[FIG. 4]: A diagram for illustrating another exemplary embodiment of liquid mixing device in accordance with the present invention.

[FIG. 5]: A fragmentary sectional view of such another exemplary embodiment of liquid mixing device in accordance with the present invention.

[FIG. 6]: A diagram for illustrating still another exemplary embodiment of liquid mixing device in accordance with the present invention.

[FIG. 7]: A fragmentary sectional view of such still another exemplary embodiment of liquid mixing device in accordance with the present invention.

[FIG. 8]: A diagram for showing an injector element in the afore-said still another exemplary embodiment in accordance with the present invention.

[FIG. 9]: A diagram for showing the injector element in the said still another embodiment of injector element in accordance with the present invention.

[FIG. 10]: A diagram for showing another exemplary embodiment of injector element in accordance with the present invention.

[FIG. 11]: A diagram for explanatorily showing operation of liquid mixing device in accordance with the present invention.

[FIG. 12]: A diagram for illustrating a conventional liquid mixing device.

[FIG. 13]: A diagram for explanatorily showing operation of the conventional liquid mixing device.

[FIG. 14]: A graph for indicating changes of pH for a mixed solution yielded by the conventional liquid mixing device

[FIG. 15]: A graph for indicating changes of pH for a mixed solution yielded by the liquid mixing device in accordance with the present invention.

### DESCRIPTION OF REFERENCE NUMERALS

2 Liquid mixing device

4 Operative mixing unit

6 Inlet port

8 Outlet port

10 Outlet extension

12 Discharge holes

14 Injection unit

16 Injector element

18 Injection holes

20 Opening region

22 Injector head

24 Connecting tube

26 Main stream

28 Flange

### BEST MODE FOR CARRYING OUT THE INVENTION

A description will be made of a liquid mixing device 2 in accordance with the present invention, with reference to the annexed drawings. FIG. 1 is a diagram for illustrating one exemplary mode of the liquid mixing device 2 of the present invention. FIG. 2 is a fragmentary sectional view of the liquid mixing device 2. In the FIG. 1, an operative mixing unit 4 of the liquid mixing device is shown to be in the state where the cylindrical body thereof is cut into one half of semi-cylindrical configuration, with a view to facilitating the ease of understanding an interior structure of that particular operative mixing unit 4. It should be understood that those two Figures are simply intended for illustrating one aspect of the present invention and are not intended to limit the invention to the illustrated embodiment.

The liquid mixing device 2 in the present mode is comprised of the operative mixing unit 4 which is formed substantially hollow, and an injection unit 14 provided in that operative mixing unit 4, the injection unit 14 being adapted for injecting a second liquid into the operative mixing unit 4.

The operative mixing unit 4 contemplated in the present invention is provided with an inlet port 6 for allowing a first liquid to flow therethrough into the operative mixing unit 4, and an outlet port 8 disposed in an opposingly facing relation with the inlet port 6. The operative mixing unit 4 may be formed in any desired shape, insofar as it has a given hollow defined therein. For example, as shown in FIGS. 1 and 2, the operative mixing unit 4 may be of a generally cylindrical shape greater in diameter than the inflow port 6, which is configured such that one surface thereof radially diverges form the inlet port 6 in a direction inwardly of the body of operative mixing unit 4, whereas another surface thereof radially tapers toward the outlet port 8. Alternatively, as shown in FIGS. 4 and 5, the operative mixing unit 4 may be of a cylindrical shape on the whole, such that a cylindrical body of the inlet port 6 is identical thereto, with two diameters respectively of the former 4 and the latter 6 being also identical to each other. In any case, the operative mixing unit 4 may be formed in an appropriate and desired shape, depending on requirements. Recommended materials for forming that operative mixing unit 4 include vinyl chloride, polyvinylidene fluoride (PVDF), polyethylene tetrafluoride (PTFE), polypropylene (PP), polymethylpentene polymer (TPX), and polyparaxylene (PPX). Of course, other proper material for that purpose may be employed in consideration of properties of first and second liquids to be used, and so forth.

As seen in FIGS. 4 and 5, a flange 28 may be provided to each of the inlet port 6 and outlet port 8. Technical specification of the flange 28, including its kind, shape, structure and sizes, may be determined in a proper manner, depending on how the operative mixing unit 4 is to be connected with a tube adapted for allowing the first liquid to flow therethrough, and other required conditions.

As shown in FIGS. 1 and 2, the outlet port 8 may be provided with an outlet extension 10. This outlet extension 10, formed in a generally cylindrical shape, extends from a base end of the outlet port 8 which is connected with the operative mixing unit 4, in such a manner as to project from that base end into the inside of the operative mixing unit 4 in a coaxial direction toward a center of that particular operative mixing unit 4. A plurality of discharge holes 12 are formed in the peripheral lateral surface of the afore-said outlet extension 10. It is noted that the outlet extension 10 may have a closed end as illustrated, or may have an opened end instead thereof. The shape, sizes and measurements of the outlet extension 10 may be properly set, depending on a discharge rate at which a mixture of first and second liquids is to be discharged therefrom, and likewise may be set the shape and number of the discharge holes 12 as well as the location of the discharge holes 12 in the outlet extension.

In accordance with the present invention, the injection unit 14 features a tubular injector element 16 provided therewith, which is designed to allow a second liquid to be injected therethrough into the inside of the operative mixing unit 4. FIG. 3 is a diagram illustrative of structural details of one exemplary mode of the injector element 16 in the present invention. This particular mode of injector element 16 is provided with injection holes 18 and an opening region 20. The number and location of those injection holes 18 to be formed in the injector element may be properly set and designed in consideration of required conditions, insofar as the injection holes 18 permit the second liquid to be squirted therefrom towards the outlet port 8. Here, such premise, “the injection holes 18 permit the second liquid to be squirted therefrom towards the outlet port 8”, refers to the condition that the injection holes 18 are so formed to permit the second liquid to be squirted therefrom in parallel with a main stream 26 or in a direction away from the main stream 26. (The term, “main stream”, is hereby defined as a rectilinear flow or stream of the first liquid in a direction from the inlet port 6 to the outlet port 8)

The opening region 20 is defined in the injector element so as to permit the first liquid to flow rectilinearly therethrough in a direction from the inlet port 6 to the outlet port 8. Such provision of opening region 20 in effect permits the second liquid to be intermixed with the first liquid, without impeding the rectilinear main stream 26. Namely, as shown in FIG. 11, the main stream 26 passes rectilinearly through the opening region 20, and therefore, the second liquid, upon its being injected adjacent to that main stream, is naturally drawn to such strong huge flow (i.e. the main stream 26). At this moment, on the other hand, a partial stream of the first liquid, which detours around the outer surface of injection element 16, flows back into the main stream 26 in convergent way. Hence, the second liquid is also caused by such partial stream of first liquid to flow into the main stream 26, in addition to being naturally drawn to the main stream 26. Consequently, it is seen that, even in the midst of the first liquid flowing through the operative mixing unit, the second liquid can be injected directly thereinto, so that both first and second liquids are automatically intermixed well to a satisfied degree. It is noted that the shape and size of the aforementioned opening region 20 may be properly determined, taking into account a diameter of the inlet port 6 and a shape of the injection element 16.

Recommended materials for forming the injector element 16 include vinyl chloride, polyvinylidene fluoride (PVDF), polyethylene tetrafluoride (PTFE), polypropylene (PP), polymethylpentene polymer (TPX), and polyparaxylene (PPX). Of course, other proper material (s) for that purpose may be used in consideration of properties of first and second liquids to be used, and so forth.

Preferably, the injector element 16 may be of a substantially ringed configuration, as shown in FIG. 3, or alternatively, it may be of a substantially U-shaped configuration shown in FIG. 10. As another alternative mode, as seen in FIGS. 8 and 9, the injector element 16 may be so formed to comprise a ringed connecting tube 24 and a plurality of injector heads 22 supportively connected with the ringed connecting tube 24. According to that mode of injector element 16, the plurality of injector heads 22 are arranged so as to project inwardly toward a center of the ringed connecting tube 24 and are each formed with injection holes 18 therein. FIGS. 6 and 7 show an exemplary mode where such particular mode of injector element 16 is provided in the liquid mixing device 2. As far as this particular mode of injector element 16 is concerned, it is seen that the opening region 20 stated above corresponds to a space defined inwardly of the ringed connecting tube 24, which is defined in the aggregate by: one space area substantially defined by a circle along which distal ends of the injector heads 22 are disposed in relation to and near to a center of the ringed connecting tube 24; and another space areas which are each defined per and between two adjoining injector heads 22, thereby providing a structure that will not impede passage of the main stream 26 therethrough. Besides those modes, any other shape and structure of the injector element 16 may be adopted, insofar as it does not impede passage of the main stream 26 therethrough and permits a second liquid to be squirted in an optimum state into the operative mixing unit 4, without any turbulent flow caused therein.

The injector element 16 is installed at a midway point in the operative mixing unit 4 as shown in FIG. 2. But, this is not absolutely required, and instead thereof, the injector element 16 may be installed at a point adjacent to the inlet port 6 or outlet port 8 in the operative mixing unit. As illustrated, the injector element 16 may be disposed orthogonal to a line extending through a center of the inlet port 6 and a center of the outlet port 8. Or, alternatively, as shown in FIG. 5, a plurality of the injector elements 16 be provided in the operative mixing unit 4. In that particular instance, those injector elements 16 may be disposed equidistant form one another as illustrated. However, in place thereof, the injector elements 16 be disposed a desired proper distance from one another. The shown injector elements 16 themselves are all identical to one another in shape, sizes and other specifications. This is however not limitative, and instead thereof, the injector elements 16 may be formed differently from one another in shape, structure and dimensions. Of course, the opening region 20 may be defined in any proper shape and dimensions by constructing associated elements circumscribing the same in various different manners.

With regard to the liquids used in the liquid mixing device 2 of the present invention, a user can prepare appropriate liquids in proper manner. For example, one of the first and second liquids may be a solution of hydrochloric acid, whereas another thereof be a solution of hypochlorite. This is a preferred mode of combination of liquids for use in the device 2 in order to prepare a dilute solution of weak acid hypochlorite having bactericidal properties.

While having described the liquid mixing device 2 of the present invention as above, it is be noted that the present invention may be subjected to any alteration and modification, depending on required conditions and specifications, without departing from the purposes of the present invention.

### Embodiment 1

For the purpose of comparison with the above-described liquid mixing device 2 of the present invention, two different liquids were used and intermixed with each other in a conventional liquid mixing device 2. Namely, the two different liquids that were used and mixed together are: a solution of hypochlorite as a first liquid; and a solution of hydrochloric acid as a second liquid, respectively. A mixture of those first and second liquids, produced by the conventional liquid mixing device, was examined as to its time-series changes of pH. Results are indicated in a first graph shown in FIG. 14. In that graph, the axis of ordinate refers to pH, whereas the axis of abscissa refers to lapse of time, wherein the axis of ordinate is scaled in 0.27 pH increments.

### Embodiment 2

The liquid mixing device 2 of the present invention is used to intermix two different liquids together therein. Namely, the two different liquids that were used and mixed together are: a solution of hypochlorite as a first liquid; and a solution of hydrochloric acid as a second liquid, respectively. A mixture of those first and second liquids, yielded by the liquid mixing device, was examined as to its time-series changes of pH. Results are indicated in a second graph shown in FIG. 15. In that graph, the axis of ordinate refers to pH, whereas the axis of abscissa refers to lapse of time, wherein the axis of ordinate is scaled in 0.27 pH increments.

According to the foregoing embodiments, the results of examination indicate that the mixture of first and second liquids, yielded by the conventional liquid mixing device, gives rise to a large range of pH changes, thus revealing an insufficient intermixed state of the two liquids, and, in contrast thereto, the mixture of first and second liquids, yielded by the liquid mixing device 2 of the present invention, achieves an extremely small range of pH changes, thus establishing that the two liquids were intermixed together well to a satisfied degree. Obviously, with the liquid mixing device 2 of the present invention, it is possible to provide a mixed solution of a stable pH.

1. A liquid mixing device which is characterized by comprising: an operative mixing unit having an inside which is substantially hollow; and an injection unit provided in said inside of said operative mixing unit, said injection unit being adapted for allowing a second liquid to be injected into the inside of the operative mixing unit, wherein said operative mixing unit is provided with: an inlet port for allowing a first liquid to flow thereinto; and an outlet port disposed in opposingly facing relation with said inlet port, wherein said injection unit is provided with an injector element of a tubular form, said injector element having: an injection hole(s) so perforated therein as to face toward said outlet portion; and an opening region defined therein so as to allow said first liquid to pass rectilinearly therethrough in a direction from said inlet port toward said outlet port.

2. The liquid mixing device as described in claim 1, which is characterized in that said injector element is disposed orthogonal to a line extending through a center of said inlet port and a center of said outlet port.

3. The liquid mixing device as described in claim 1, which is characterized in that a plurality of said injector elements are provided in said inside of said operative mixing unit.

4. The liquid mixing device as described in claim 1, which is characterized in that said outlet port is provided with an outlet extension, that said outlet extension is so formed to have a generally cylindrical body which extends from a base end of said outlet port in such a manner as to project from said particular base end towards a center of said operative mixing unit, and that a plurality of discharge holes are formed in a peripheral surface of said generally cylindrical body.

5. The liquid mixing device as described in claim 1, which is characterized in that said injector element is of a generally ringed shape.

6. The liquid mixing device as described in claim 1, which is characterized in that said injector element is of a generally “U” shape.

7. The liquid mixing device as described in claim 1, which is characterized in that said injector element comprises: a ringed connecting tube; and a plurality of injector heads connected with said ringed connecting tube, wherein said plurality of injector heads each has said injection holes and projects towards a center of said ringed connecting tube.

8. The liquid mixing device as described in claim 1, which is characterized in that one of said first and second liquids is a solution of hydrochloric acid, whereas another of said first and second liquids is a solution of hypochlorite.
